(19) United States
(12) Patent Application Publication
(10) Pub. No.: US 2005/0097338 A1
(43) Pub. Date: May 5, 2005

(54) Biometrics parameters protected USB interface portable data storage device with USB interface accessible biometrics processor

(76) Inventor: Kong Pheng Lee, Singapore (SG)

Correspondence Address: CLARK & BRODY, 1090 VERMONT AVENUE, NW, SUITE 250, WASHINGTON, DC, 20005, US

(21) Appl. No.: 10/909,413

(22) Filed: Aug. 3, 2004

(30) Foreign Application Priority Data
Oct. 30, 2003 (SG) 200306442-5

(51) Int. Cl. H04K 1/00

(52) U.S. Cl. 713/186

(57) ABSTRACT

A biometric parameters protected USB interface portable data storage device which integrates generic USB interface with biometric (Fingerprint) technologies to ensure data and information storage within the device are secured with personal biometrics information. The biometric processing unit is securely accessed by USB host to perform various biometrics functionalities at the control of application software running in the PC or USB On-the-Go host. The biometrics functionalities include fingerprint scanning, fingerprint bio-data generation and encryption, comparison of fingerprint bio-data and storing of fingerprint bio-data. The storage acts as a portable hard disk that can only be accessed by the user(s) with the authorized fingerprint biodata and at the same time the USB accessible biometrics processing unit of the device offers unlimited application for the application software operating in PC host and USB On-the-Go devices.

### BACKGROUND OF THE INVENTION

(1) Field of the Invention

The present invention relates to a USB compound device, including a USB portable data storage device and a USB biometrics processing unit. In particular, the USB portable data storage device is accessed with biometrics (Fingerprint) technology to ensure data and information storage within the device is secured with personal biometrics information. In addition, the biometric unit can be securely accessed by PC or USB On-the-Go host to perform various biometrics functionalities at the control of application software running in the PC or USB On-the-Go host.

(2) Description of the Prior Art

Conventional devices employ a sensoring device for sensing biometric characteristics such that the device is connected via USB to a system and that biometric identification is required to launch the function of the said system. U.S. Pat. No. 6,125,192 issued to Vance C Bjorn et al on 26 Sep. 2000 discloses a fingerprint sensor that is connected to a digital system via USB such that access of the digital system requires fingerprint authentication. Similarly, U.S. Pat. No. 6,353,472 issued to Richard V Bault on 5 Mar. 2002 discloses a device for the authentication of a person by his fingerprints prior to an authorization for an operation, and that the connection of this device to the mode of operation can be performed via USB interface. None of the above prior art have suggested the use of fingerprint authentication on a portable hard disk which can be linked to a computer platform via USB such that fingerprint authentication is required to access information stored in the said disk. In addition, the biometrics processing unit of the computer platform can be accessed externally by the USB host to perform various functions including authorization of door and computer access, scanning of fingerprint image, e-banking and other fingerprint identification tools.

U.S. Pat. No. 4,210,899 issued to Swonger et al. on 1 Jul. 1980 discloses an optical scanning fingerprint reader cooperating with a central processing station far a secure access application, such as admitting a person to a location or providing access to a computer terminal. U.S. Pat. No. 4,525,859 issued to Bowles on 25 Jun. 1985 similarly discloses a video camera for capturing a fingerprint image and uses the minutiae of the fingerprints, that is, the branches and endings of the fingerprint ridges, to determine a match with a database of reference fingerprints. Unfortunately, one shortcoming of this technique is that stained fingers may affect optical sensing or an optical sensor may be deceived by presentation of a photograph or printed image of a fingerprint rather than a true live fingerprint. Optical sensors may be bulky and susceptible to shock, vibration and surface contamination. Additionally, an optical fingerprint sensor may be unreliable in service in addition to being bulky and relatively expensive due to optics and moving parts. It is therefore an object of the present invention to provide a biometrics parameters protected USB interface portable data storage device with USB accessible interface Biometrics processor and is a fingerprint sensor and related methods for accurately sensing a fingerprint, and which sensor is compact, reliable and relatively inexpensive. Accordingly, the many shortcomings and disadvantages of conventional optical sensors are overcome in the present invention with the use of capacitive or electric field sensors.

Singapore Patent No. 96688 issued to Ritronics Components Singapore Pte Ltd (SG) discloses a biometrics protected USB portable data storage device. However, compared to the present invention, the prior art device does not allow its biometrics processing unit to be accessed directly by its USB host.

WIO 03/003283 A1 discloses a portable device having biometrics-based authentication capabilities. However, enrollment of such device requires that administration software be installed in the PC host. In addition, access to the nonvolatile memory of the portable device can be achieved using a password as an alternative to the biometric authentication.

### SUMMARY OF THE INVENTION

Accordingly, it is an object of the invention is to provide a USB device which includes a biometrics processing unit and a biometrics parameters protected USB portable data storage device. The information storage within the device is secured with personal fingerprint bio-data by the biometrics fingerprint processing unit and the same biometrics fingerprint processing unit can be accessed by USB host devices to perform various biometrics (fingerprint) functionalities. In addition, the communication path between any computer platform (with USB host) and the device is via a USB client/host interface.

Yet another object of the present invention is to provide a portable data storage, wherein, the biometric processing unit can be securely accessed by USB fingerprint biodata, only the person with the authorized fingerprints can activate the function of the storage device. In addition, the device also can be served as a biometric (Fingerprint) processing unit for USB host devices including PC host and USB On-the-Go devices, independently from the data storage functionality host to perform various biometrics functionalities at the control of application software running in the PC or USB On-the-Go host. Such biometrics functionalities include fingerprint scanning, fingerprint bio-data generation and encryption, comparison of fingerprint bio-data and storing of fingerprint bio-data. The device acts as a portable hard disk with a biometrics processing unit which can be connected via USB interface onto USB host. The USB host can then access and retrieve data stored in the storage device or store data into the storage device. As the data in the device is protected by a personal.

A further object of the present invention is to provide a portable data storage device, wherein the device is solely biometrics protected and no password is involved in any authorization access of the non-volatile memory. In addition, there is no USB connection to the data processing unit of the device until after authorized fingerprint is authenticated.

According to one aspect of the present invention, there is disclosed a portable data storage device comprising:
an embedded fingerprint biometrics processing unit and sensor, wherein the sensor is one of a capacitive or electric field sensing device;
a plurality of non-volatile solid state read/write memories forming a storage module arranged to store data;
a processor unit for interfacing with the embedded fingerprint processing unit, the storage module, and a host computer system to which said portable data storage device is connectable, said processor unit being operable as a and the memory storage, and being a gateway for data to store/retrieve in/from a flash memory with biometric information protection;
a data encryption or a data protection scheme for data and information safekeeping within the non-volatile solid state read/write memories; and
a proprietary enrollment scheme for biometric fingerprint enrollment.

An embodiment of the invention uses a data encryption scheme. In the present invention, the 56-bit Blowfish encryption is used to encrypt the data within the device. However, any encryption can be used to encrypt the data within the device.

An embodiment of the invention uses a data protection scheme. The data protection scheme prevents the physical removal of the non-volatile solid state read/write memories easily from the printed circuits board. Any attempt to remove the non-volatile solid state read/write memories will likely resulted the memories physically broken. In the present invention, the epoxy is used to physically bound the memories to the printed circuits board.

Another embodiment provides a Biometrics parameters protected USB interface portable data storage device with USB accessible interface Biometrics processor, wherein the fingerprint biometrics processing is not only used to protect the data access to and from the portable data storage, but can also be accessed by USB host without compromising to the security of data within the device. This additional inventive step enables many biometrics related application to be developed on top of the device. Such applications include but not limited to secured PC access control, door access control, secure internet banking, secure access to auto teller machine, secure e-ticketing. The transactions of such accesses can even be stored within the device itself.

The present disclosure provides a biometrics parameters protected USB interface portable data storage device as is an easy to use portable miniature data storage device with high storage capacity. The device is small in size and is capable of storing huge files such as accounting data files, CAD files, huge presentation files, multimedia files.

Another embodiment provides a biometrics parameters protected USB interface portable data storage device, which does not require the installation of administration software for fingerprint enrollment, authentication and verification.

Another embodiment provides a biometrics parameters protected USB interface portable data storage device, wherein the authorization access to the data storage is only by authorized fingerprint and not by password or token.

Another embodiment provides a biometrics parameters protected USB interface portable data storage device which is user friendly, just plugged it into any computer platform via the USB interface unit, and provide the authorized fingerprint and data can be accessed on the computer platform.

Another embodiment provides a fast method of accessing the data stored in the biometric parameters protected USB interface portable data storage device. This can be seen from its short biometrics verification and system access time of not more than 1 second. Also the typical biometrics enrollment time is not more than 1 second per user.

Another embodiment provides a biometric parameters protected USB interface portable data storage device which not more than 10 users are assigned for authority access right.

Another embodiment provides a biometrics parameters protected USB interface portable data storage device, which includes a set of master user fingerprint bio-data and another set of normal user fingerprint bio-data. The master user is able to erase the fingerprint bio-data of both the master and the normal user, while the normal user is only able to erase his own fingerprint bio-data.

### BRIEF DESCRIPTION OF THE DRAWINGS

At best one embodiment of the present invention will now be described with reference to the accompanying drawings, in which:

FIG. 1 is a schematic view of the biometrics parameters protected USB interface portable data storage device; and

FIG. 2 is a System Functional Block Diagram, of the device of FIG. 1.

### DETAILED DESCRIPTION OF THE INVENTION

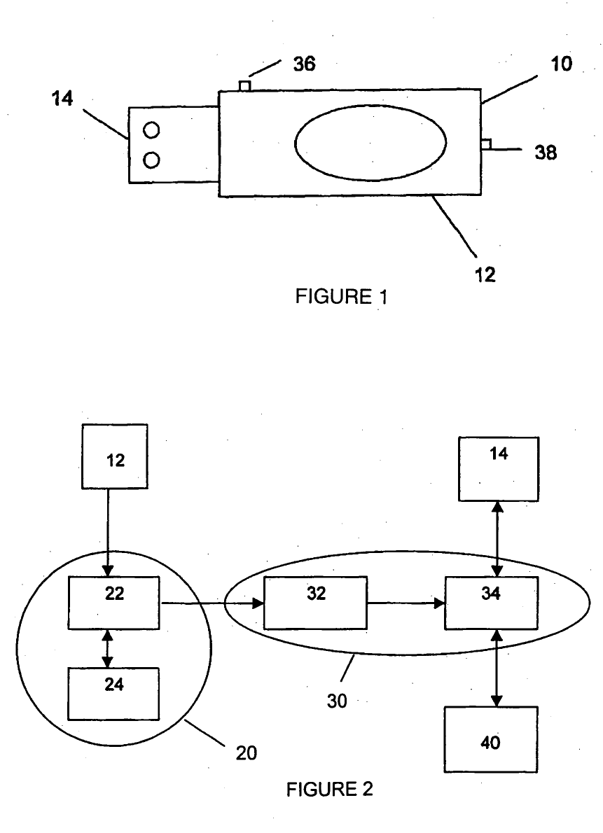

FIG. 1 shows a portable data storage device 100 which comprises a USB interface unit 14, a fingerprint sensor 12 and a casing 10. With reference to FIG. 1, the casing 10 encloses an embedded fingerprint biometrics processing unit 20, a USB Hub 16, a biometrics access switch 38, a fingerprint enrollment switch 36, an access control decision (a micro-controller) unit 32, a data processing unit 34 and a plurality of nonvolatile solid state read/write memory 40. In the embodiment illustrated, the fingerprint sensor 12 is connected to the fingerprint biometric processing unit 20. The biometrics processing unit 20 is connected to the access control decision (a micro-controller) unit 32, which is connected to the data processing unit 34.

Referring again to FIG. 2, when in application, the user of the device can switch the biometrics access switch 38 to either data storage or biometrics access before plugging the device onto the USB host.

If the selection is to access the data storage within the device 100, the user of the data storage device 100 places his finger onto the fingerprint sensor 12 (which acts as a reader). The sensor 12 scans the user's fingerprint and the fingerprint bio-data is sent to the embedded fingerprint biometrics processing unit 20. The embedded fingerprint biometrics processing unit 20 verifies the fingerprint bio-data with enrolled bio-data that had previously stored and secured as an Encryption Key in a bio-data storage unit within the micro-controller 32. If the verification is unsuccessful, the user will be denied access to the data in the non-volatile solid-state read/write memory 40 or have his fingerprint re-scanned. When the verification is successful, the micro-controller 32 instructs the data processing unit 34 to retrieve the information stored in the nonvolatile solid state read/write memory 40 and sends the information to the USB host or to store the information from USB host on to the non-volatile solid state read/write memory 40. The information that is stored in the non-volatile solid-state read/write memory 40 can be encrypted by the encryption software running in the USB host.

The user has to enroll his fingerprint bio-data into the embedded fingerprint biometrics processing unit 20. In the first enrollment, the user will have his fingerprint scanned by the fingerprint sensor 12, and the fingerprint bio-data will be processed by the biometrics processing unit 20 and then stored in the access control unit 32. The user must have his fingerprint scanned 3 times per finger to ensure an accurate reading of the fingerprint bio-data by the biometrics processing unit 20 before being stored into the access control unit 32. Up to a maximum of 10 users can be enrolled.

After the first user is enrolled, if another user wants to have access to the information stored in the device, he will have to be re-enrolled. Before he can be enrolled, the first user must have his fingerprint authenticated first, and if it is successful, the subsequent users can have their fingerprint bio-data enrolled. Their enrollment process is the same as the first user.

The enrolled fingerprints are further classified into 2 categories—master fingerprints and normal fingerprints. The first two fingerprints enrolled are master fingerprints. The master fingerprints have the right to completely erase the device fingerprint bio-data. The enrollment switch 36 is used to differentiate among master re-enrollment, normal re-enrollment and normal device operation.

In accordance with the present invention, the typical biometrics verification and system access time of the portable data storage device is not more than 1 second, and the biometrics enrollment time is not more than 1 second per user, and not more than 10 users are assigned for authority access right.

If the biometrics access switch 38 is set to allow the access of the embedded fingerprint biometrics processing unit 20 by the USB host, the access control decision (a micro-controller) unit 32 enables the USB connection between the embedded fingerprint biometrics processing unit 20 with the USB host. In the present invention, a PC access control software is provided together with the device. The software employed in this method includes the PC access control as well as the data encryption functionality. However, the present invention provides the platform for further software development and it is not only applicable to PC host but also available to USB-On-the Go host. In addition, the non-volatile solid-state read/write memory 40 is physically protected by epoxy to prevent physical removal of memory 40.

It is a common general knowledge that with the advanced of semiconductor and firmware technology, combination of the above processing units including fingerprint biometrics processing unit 20, a USB Hub 16, an access control decision (a microcontroller) unit 32 and a data processing unit 34 to one or two physical units is possible.

While the present invention has been described by means of specific embodiment, it will be understood that modifications may be made without departing from the spirit of the invention. The scope of the invention is not to be considered as limited by the description of the invention set forth in the specification, but rather as defined by the following claims.

1. A portable data storage device with USB accessible biometrics processor comprising:
an embedded fingerprint biometrics processing unit and sensor, wherein the fingerprint biometrics processing unit is accessible externally by USB host and internally within the device;
a plurality of non-volatile solid state read/write memories for data and information storage;
a processor unit for interfacing with the embedded fingerprint system, a USB host and the non-volatile solid state read/write memories;
a data encryption or a data protection scheme for data and information safekeeping within the non-volatile solid state read/write memories; and
an enrollment scheme for biometric fingerprint enrollment.

2. The portable data storage device of claim 1, wherein the authorization access to the data storage is only by authorized fingerprints.

3. The portable data storage device as in claim 1, wherein a micro-controller and the embedded fingerprint biometric processing unit within the device are employed so as to authorize the read and write access of the non-volatile solid state read/write memories.

4. The portable data storage device of claim 1, wherein bio-data for authentication of any unauthorized access to the non-volatile solid state read/write memories is stored within the device.

5. The portable data storage device of claim 4, wherein the bio-data is inaccessible by the USB host.

6. The portable data storage device of claim 4, wherein users fingerprint bio-data include master fingerprint bio-data and normal user fingerprint bio-data, and the master user is able to erase the bio-data of both the master and the normal user, while the normal user is only able to erase his own bio-data.

7. The portable data storage device of claim 1, wherein an enrollment switch is used to differentiate fingerprint enrollment and normal device authentication operation.

8. A method of using a biometric parameters protected portable data storage device, said method comprising the steps of:
scanning user's fingerprint by a fingerprint sensor;
processing the scanned fingerprint image by a biometrics processing unit which verifies the image with the user(s) fingerprint bio-data which is in a bio-data storage unit; and
requesting another fingerprint for scanning again from the user if the verification fails.

9. The portable data storage device of claim 1, wherein the typical biometrics verification and system access time is not more than 1 second.

10. The portable data storage device of claim 1, wherein the biometrics enrollment time is not more than 1 second per user, and not more than 10 users are assigned for authority access right.

11. The portable data storage device of claim 1, wherein the memories of the nonvolatile solid stage read/write memories include flash memories.

12. The portable data storage device of claim 11, wherein the memories of the nonvolatile solid stage read/write memories are magneto-resistive random access memories commonly (MRAM).

13. The portable data storage device as in claim 2, wherein a micro-controller and the embedded fingerprint biometric processing unit within the device are employed so as to authorize the read and write access of the non-volatile solid state read/write memories.

14. The portable data storage device of claim 2, wherein bio-data for authentication of any unauthorized access to the non-volatile solid state read/write memories is stored within the device.
